(19) United States
(12) Patent Application Publication
(10) Pub. No.: US 2008/0220829 A1
(43) Pub. Date: Sep. 11, 2008

(54) MOBILE TERMINAL DEVICE, METHOD OF POWER SAVING CONTROL FOR MOBILE TERMINAL DEVICE AND COMPUTER PRODUCT

(76) Inventors: Katsuaki Akama, Kawasaki (JP); Hiroshi Tsuge, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/036,418

(22) Filed: Feb. 25, 2008

(30) Foreign Application Priority Data
Mar. 9, 2007 (JP) 2007-59753

(51) Int. Cl. H04M 1/00

(52) U.S. Cl. 455/574

(57) ABSTRACT

A mobile terminal device having a display includes an image capturing unit capturing an image at a prescribed periodical timing; an image changing detector detecting an image change exceeding a prescribed extent between the image captured at a prescribed timing and one or more of images obtained at a previous timing; and a power saving controller controlling a power saving state of the display depending on whether an image change exceeding the prescribed extent is detected.

### CROSS-REFERENCE TO RELATED APPLICATIONS

This application is related to and claims priority to Japanese patent application no. 2007-0559753 filed on Mar. 9, 2007 in the Japan Patent Office, and incorporated by reference herein.

### BACKGROUND

1. Field

The embodiments relate to a technology for controlling a power saving state. More particularly, the embodiments relate to a mobile terminal device having an internal camera, a method of power saving control and a computer product.

2. Description of the Related Art

A mobile terminal device is generally provided with a power saving function not to waste a battery. The mobile terminal device is put into a power saving state when a predetermined time period passes after a user's key operation. The display is turned off or the display brightness is reduced when the mobile terminal device is in the power saving state. The power saving state is cancelled by operating a key of the mobile terminal device, receiving an incoming call/mail or the like.

However, usability of the mobile terminal device may be bad because the display is turned off by the above-described power saving function. For example, the mobile terminal device indicating time in the display may be stationed or put on a table or other surface/stand when a user uses a clock function of the mobile terminal device as a clock. In this case, the power saving function puts the display of the mobile terminal device into a light-off state when the predetermined time period passes. Therefore, a user needs to touch a key of the mobile terminal device every time user checks the time.

Further, a user may stop operation for any reason during looking up in a phone directory, inputting a mail text or the like. In this case, the power saving function puts the display of the mobile terminal device into the light-off sate when the predetermined time period passes. In order to restart the operation, a user needs to cancel the power saving state by touching a key of the mobile terminal device. However, the display may become different from the previous display which is in the power saving state due to the key operation for cancelling the power saving function.

Japanese Laid-Open Patent Publication No. 2001-005437 discloses a technology for obtaining brightness and color temperature of a surrounding of a personal computer. In this technology, the brightness and the color temperature of the surrounding of the personal computer are obtained by a camera connected to the personal computer. Then, a difference between the brightness and the color temperature of the personal computer display and those of the surrounding of the personal computer are controlled to be constant. Therefore, the technology disclosed in Japanese Laid-Open Patent Publication No. 2001-005437 can control brightness and color temperature of the display according to the surrounding environment. In the technology described in Japanese Laid-Open Patent Publication No. 2001-005437, however, the display which is in the light-off state due to the power saving function can not be put into a light-on state.

### SUMMARY

In an unlimiting example, according to an aspect of the embodiments, the above-mentioned example problems in the conventional technology are overcome.

According to an aspect of an embodiment, a mobile terminal device having a display, includes an image capturing unit that obtains an image captured at a prescribed periodical timing; an image changing detector that detects an image change exceeding a prescribed extent between the image obtained by the image capturing unit at a prescribed timing and one or more of the images obtained at a previous timing; and a power saving controller that controls a power saving state of the display depending on whether or not an image change exceeding the prescribed extent is detected by the image changing detector.

According to another aspect of the embodiments, a method of controlling power saving in a mobile terminal device having a display includes capturing an image at a prescribed periodical timing; detecting an image change exceeding a prescribed extent between the captured image and one or more of images captured at a previous timing; and controlling a power saving state of the display depending on whether or not an image change exceeding the prescribed extent is detected between the images during image change detection.

According to still another aspect of the embodiments, a mobile terminal device having an image capturing unit includes an image changing judgment unit that compares a first image captured by the image capturing unit at a first timing and a second image captured by the image capturing unit at a second timing which is different from the first timing, and determines whether or not there is an image change between the first image and the second image; and a power saving control unit that controls the power saving state of the mobile terminal device based on a determination result produced by the image changing judgment unit.

The above example objects and other objects, features, advantages and technical and industrial significance of this embodiment will be better understood by reading the following detailed description of present preferred embodiments, when considered in connection with the accompanying drawings.

### BRIEF DESCRIPTION OF THE DRAWINGS

FIG. 1 is a block diagram of the configuration example of a mobile terminal device.

FIGS. 2A, 2B, 2C and 2D are diagrams showing an example of a power saving control using image change detection.

FIG. 3 is a functional block diagram of the configuration example of a mobile terminal device including radio communication according to a present embodiment.

FIG. 4 is a diagram showing an example appearance of a mobile telephone as the mobile terminal device including radio communication.

FIG. 5 is a flow chart of judgment processing in which a power saving state is cancelled by an image change.

FIG. 6 is a flow chart of image changing judgment processing.

FIG. 7 is a diagram explaining image changing judgment processing of a present embodiment.

FIG. 8 is a hardware block diagram of an image changing detecting circuit.

### DETAILED DESCRIPTION OF THE PREFERRED EMBODIMENTS

The present embodiment is described using figures as follows. A power saving control of a mobile terminal device display is mainly explained as below. The present embodiment is also applicable to other power saving control other than the power saving control of the mobile terminal device display.

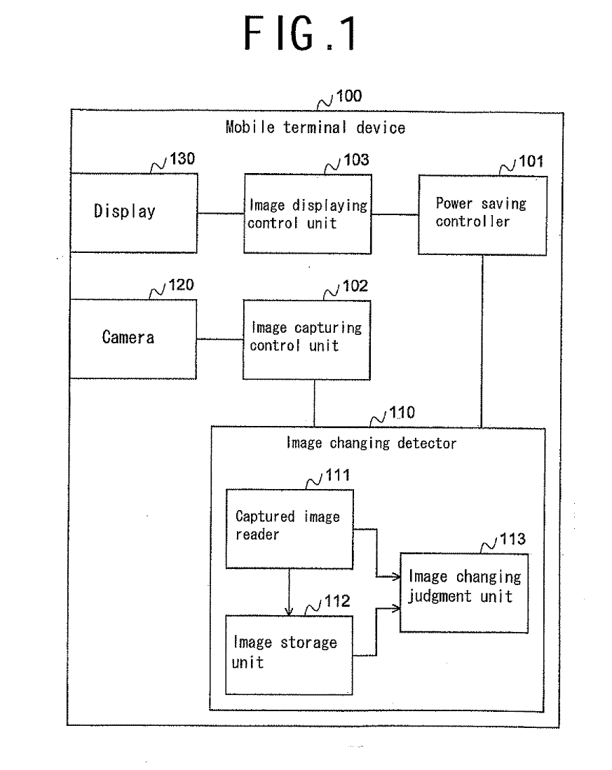

In FIG. 1, the mobile terminal device 100 includes a power saving controller 101, an image capturing control unit 102, an image displaying control unit 103, an image changing detector 110, an image capturing unit (hereinafter referred to as a “camera”) 120, and a display 130. The camera 120 is provided inside the mobile terminal device 100. The display 130 is provided inside the mobile terminal device 100.

The power saving controller 101 controls the power saving state of the mobile terminal device 100. For example, the mobile terminal device 100 is put into the power saving state when the predetermined time period passes after a last key operation, call making/receiving or mail sending/receiving. When the mobile terminal device 100 is in the power saving state, if a key is operated, a call is made/received, a mail is sent/received or an image change is detected by the image changing detector 110, or any combinations thereof, the power saving state of the mobile terminal device 100 is cancelled.

The image capturing control unit 102 controls the camera 120 and obtains an image captured by the camera 120. The image displaying control unit 103 displays an image in the display 130 and controls the power saving state of the display 130. The image displaying control unit 103 reduces brightness of the display 130 and/or turns off a screen of the display 130 when the image displaying control unit 103 is put into the power saving state by the power saving controller 101. The image displaying control unit 103 increases the brightness of the display 103 and/or turns on the screen of the display 103 when the power saving state is cancelled by the power saving controller 101.

The image changing detector 110 obtains images captured by the camera 120 at a predetermined time interval so as to detect an image change between the obtained images. The image changing detector 110 includes a captured image reader 111, an image storage unit 112, and an image changing judgment unit 113. The captured image reader 111 obtains an image captured by the camera 120. The image storage unit 112 stores an image obtained by the captured image reader 111. The image changing judgment unit 113 compares the image obtained by the captured image reader 111 and the previous image stored by the image storage unit 112 so as to determine whether or not there is an image change exceeding a prescribed extent between the images.

In FIG. 1, the display 130 of the mobile terminal device 100 is in a light-off state when the display 130 is put into the power saving state. In this case, the camera 120 is in an active state. For example, the captured image reader 111 of the image changing detector 110 obtains images captured by the camera 120 at a predetermined 0.5 second interval. The images obtained by the captured image reader 111 are stored in the image storage unit 112.

The image changing judgment unit 113 compares a latest image obtained by the captured image reader 111 and one or more of the images obtained at the previous timing and stored by the image storage unit 112 so as to determine whether or not there is an image change exceeding the prescribed extent between the images. For example, a similarity between an image captured by the captured image reader 111 and an image stored by the image storage unit 112 is measured. Then, it is determined that there is an image change between the images if an extent of similarity between the images is smaller than a predetermined threshold value.

The power saving controller 101 cancels the power saving state of the mobile terminal device 100 if an image change is detected by the image changing detector 110. Also, the image displaying control unit 103 puts the display 130 into a light-on state, according to such power saving cancellation. According to another aspect of an embodiment, the power saving controller 101 may cancel the power saving state of the mobile terminal device 100 if the image changing detector 110 detects an image change is detected at a consecutive timing more than the number of times which is prescribed by the image changing detector 110.

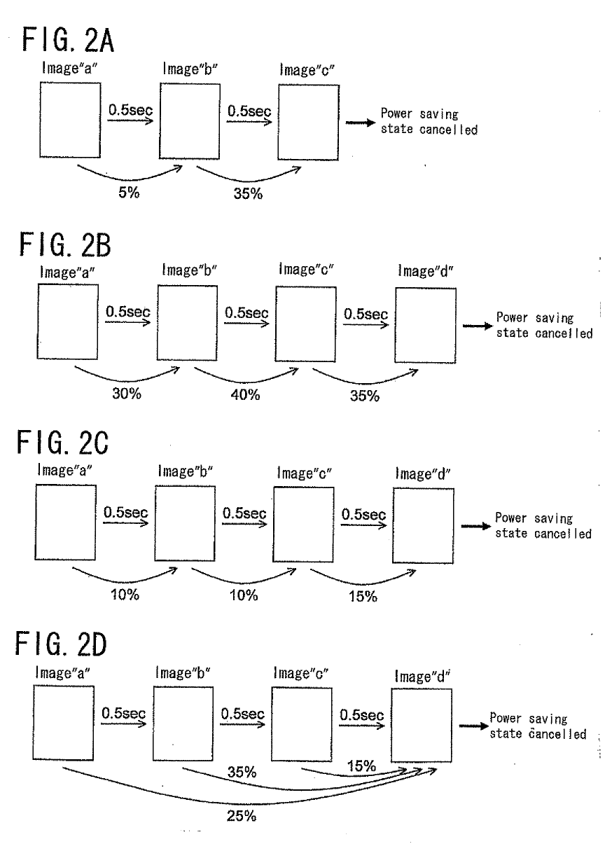

In FIGS. 2A, 2B, 2C and 2D, images are obtained at a 0.5 second interval. FIGS. 2A, 2B, 2C and 2D explain that an amount of image change is expressed in percentage terms. A predetermined value (threshold value) which is used by the image changing detector 110 for image change detection has to be bigger than 30 percent of the amount of the image change. The amount of the image change shown in FIGS. 2A, 2B, 2C and 2D are provided merely for an explanation. There may be considered various methods as practical methods using the predetermined value for image change detection, e.g., a method for calculating the extent of similarity between the images so as to determine that there is an image change if the extent of similarity is smaller than the predetermined value or a method for measuring the amount of brightness change in the center of the image so as to determine that there is an image change if the image change is bigger than the predetermined value.

FIG. 2A shows a first example of the power saving state cancelled judgment. In the example of FIG. 2A, the power saving state is cancelled if once an image change is detected. An image “a” is obtained at a time and an image “b” is obtained 0.5 seconds later. In this case, the image change between the image “a” and the image “b” is not detected because the amount of the image change between the image “a” and the image “b” is 5 percent. As a result, the power saving state of the display 130 is not cancelled. Next, when an image “c” is obtained 0.5 seconds after the image “b” is obtained, the amount of the image change between the image “b” and the image “c” is 35 percent. Thus, the power saving state is cancelled because it is determined that the image change is detected.

The power saving state of the display is a state in which display brightness is reduced and/or a display is turned off to save the power. Cancelling the power saving state of the display refers to when a display having a state in reduced brightness and/or the light-off state is put into the light-on state having brightness in which the mobile terminal device is normally used. According to an aspect of an embodiment, cancelling the power saving state of the display refers to resetting a power save determination process for maintaining the light-on state having brightness in which the mobile terminal device is normally used.

FIG. 2B shows a second example of the power saving state cancelled judgment. In the example of FIG. 2B, the power saving state is cancelled if an image change is detected at more than three consecutive timings. When the image “a” is obtained at a time and the image “b” is obtained 0.5 seconds later, the amount of the image change between the image “a” and the image “b” is 30 percent. Thus, a counter of image change consecutive number has one count because it is determined that the image change is detected. Next, when the image “c” is obtained 0.5 seconds after the image “b” is obtained, the amount of the image change between the image “b” and the image “c” is 40 percent. Thus, the counter of image change consecutive number has two counts because it is determined that the image change is detected. Then, when the image “d” is obtained 0.5 seconds after the image “c” is obtained, the amount of the image change between the image “c” and the image “d” is 35 percent. Thus, the counter of image change consecutive number has three counts because it is determined that the image change is detected. The power saving state of the display 130 is cancelled because an image change is detected at three consecutive timings.

FIG. 2C shows a third example of the power saving state cancelled judgment. In the example of FIG. 2C, it is determined that an image change is detected according to the total amount of the image changes detected at three consecutive timings. When the image “a” is obtained at a time and the image “b” is obtained 0.5 seconds later, the amount of the image change between the image “a” and the image “b” is 10 percent. Next, when the image “d” is obtained 0.5 seconds after the image “c” is obtained, the amount of the image change between the image “c” and the image “d” is 15 percent. It is determined that an image change is detected because the total amount of the image changes detected three times consecutively is 35 percent. As a result, the power saving state of the display 130 is cancelled.

FIG. 2D shows a fourth example of the power saving state cancelled judgment. In the example of FIG. 2D, three images obtained at the past three time consecutive timings are compared with a most recent captured image “d” so as to detect an image change between the images. It is determined that an image change is detected if the amount of image change between any of the images is bigger than the predetermined value. The image “a” is obtained at a time, and the image “b” is obtained 0.5 seconds later. When the image “c” is obtained 0.5 seconds after the image “b” is obtained, the amounts of image changes among the image “a”, “b”, “c” and “d” are 25, 35, and 15 percent, respectively. It is determined that an image change is detected because the amount of image change between the image “b” and the image “d” is 35 percent. As a result, the power saving state of the display 130 is cancelled.

Any combinations of the image change detections of FIGS. 2A-2D can be provided. There may be considered various methods including any combinations thereof as methods for determining an image change detection other than the example shown in FIGS. 2A, 2B, 2C and 2D or in any combinations with FIGS. 2A-2D image change detections, such as a method for determining depending on an amount of image change between an image and an image obtained at three times earlier timing. A method for determining an image change detection has only to determine whether or not to cancel the power saving state of the display 130 according to the detection of image change which is bigger than the predetermined value between the images obtained at a predetermined timing. According to an aspect of an embodiment, any combinations of FIGS. 2A-2D methods or other methods can be used to cancel/abort a power saving state and/or reset a power saving determination process.

In this way, for example, the display 130 which is put into the light-off state by a power saving function in the mobile terminal device 100 is put into the light-on state when a user waves his/her hand for a few seconds in front of the camera 120 provided inside the mobile terminal device 100. This is because the image is changed by user's operation, so that the image change is detected. That is, a user can cancel the power saving state of the display 130 so as to put the display 130 into the light-on state without a key operation.

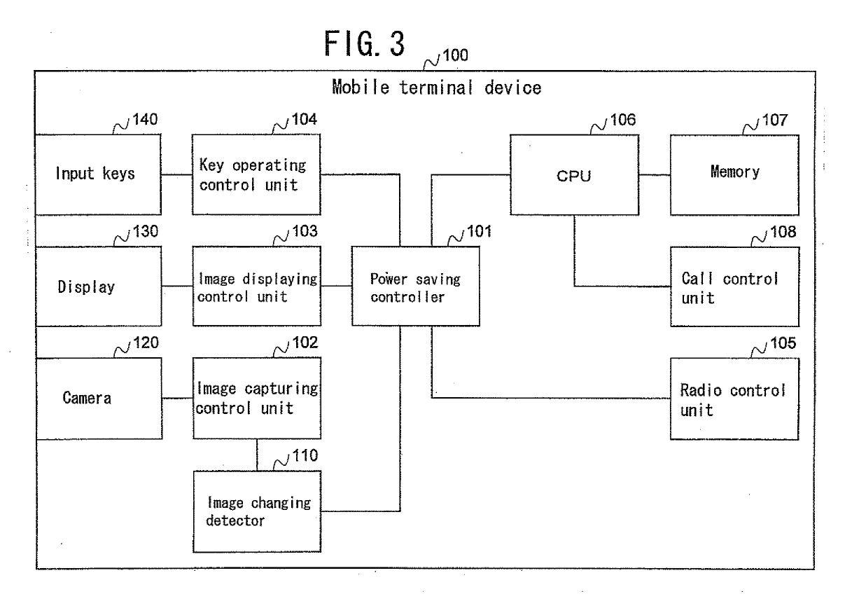

FIG. 3 shows a functional block diagram of the configuration example of a mobile terminal device including radio communication according to a present embodiment. In FIG. 3, a configuration is mainly shown to explain a control related to the power saving function.

The mobile terminal device 100 includes the power saving control unit 101, the image capturing control unit 102, the image displaying control unit 103, the camera 120, the display 130 and an input key 140 and further includes a key operating control unit 104, a radio control unit 105, a CPU 106, a memory 107, and a call control unit 108.

The power saving controller 101 controls the power saving state of the mobile terminal device 100. The image capturing control unit 102 controls the camera 120 and obtains an image captured by the camera 120. The image displaying control unit 103 displays an image in the display and controls brightness of the display 130. The key operating control unit 104 accepts user's operation from the input key 140. For example, the radio control unit 105 performs radio control between the mobile terminal device 100 and a base station as a mobile wireless communication device and/or phone. The CPU 106 processes a software program expanded in the memory 107. The memory 107 stores the software program or data. The call control unit 108 performs call control using an originating phone number. The image changing detector 110 obtains images captured by the camera 120 at the predetermined time interval so as to detect an image change between the obtained images.

In the mobile terminal device 100, the power saving controller 101 puts the mobile terminal device 100 into the power saving state when the predetermined time period passes after the last action, i.e., operating the input key 140, making/receiving a call, sending/receiving a mail or using an application or any combinations thereof. Then, the power saving controller 101 cancels the power saving state if any combination of the following is detected, i.e., a user's operation of the input key 140, an incoming call/mail or an image change between the images periodically captured by the camera 120.

As a condition for putting the mobile terminal device 100 into the power saving state, there may be a condition that the image changing detector 110 detects no image change more than the predetermined time period. That is, it is possible not to put the mobile terminal device 100 into the power saving state if the image change is detected between the images obtained by the camera 120 at the predetermined time interval without operation of the input key 140, making/receiving a call, sending/receiving a mail and/or operation of an application.

The image displaying control unit 103 reduces the brightness of the display 130 and/or turns off the screen of the display 130 when the image displaying control unit 103 is put into the power saving state by the power saving controller 101. The image displaying control unit 103 turns on the screen of the display when the power saving state is cancelled.

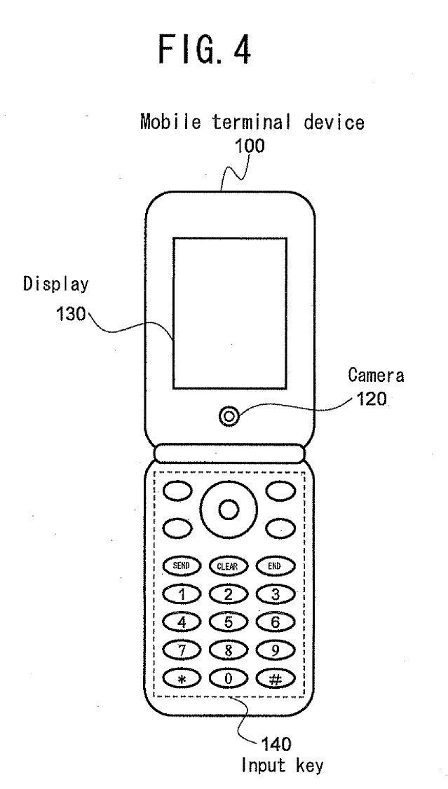

FIG. 4 shows an example of an appearance of the mobile terminal device 100 including radio communication as a mobile phone which is a folding type. The camera 120 is a digital camera provided inside the mobile terminal device 100. In FIG. 4, an In-camera 120 is shown in the mobile terminal device 100 which is in the unfolded state. Also, there is an Out-camera on the back side of the mobile terminal device 100. The display 130 includes a LCD screen provided inside the mobile terminal device 100. The input key 140 includes buttons such as keypads, an enter key, a start voice call key and the like, which are operated by a user.

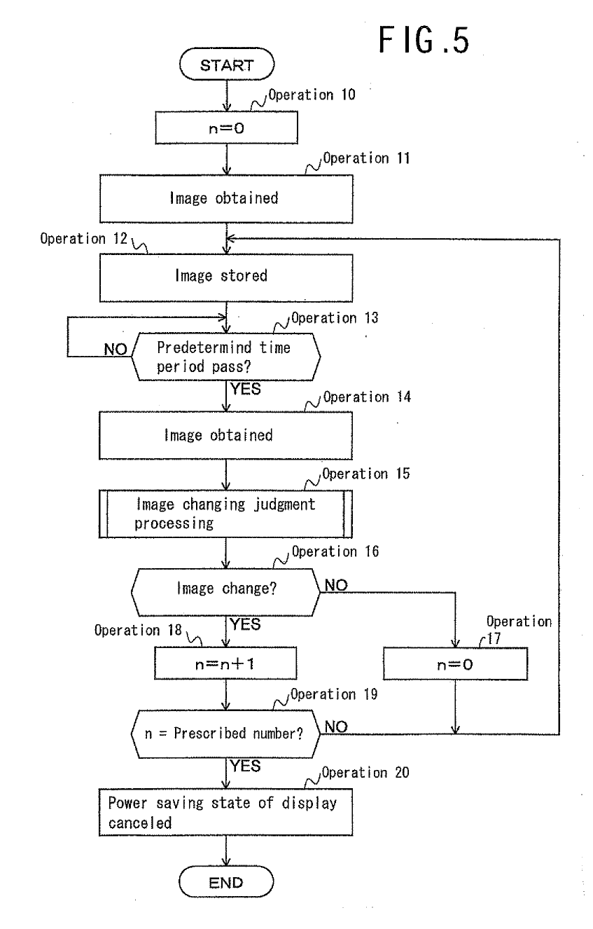

FIG. 5 is a flow chart of judgment processing in which a power saving state is cancelled by an image change. FIG. 5 shows an example of judgment processing for cancelling the power saving state by an image change. The power saving state is cancelled if an image change is detected at consecutive timings more than prescribed number of times. In this case, the display 130 is put into the power saving state and the camera 120 is activated at the same time. Thus, the judgment processing is started by the power saving controller 101 and the image changing detector 110.

A counter “n” for consecutive number of image change is reset to 0 (Operation 10). First, an image captured by the camera 120 is obtained (Operation 11). Then, the obtained image is stored (Operation 12).

The mobile terminal device 100 stays in a standby state until the predetermined time period passes (Operation 13). The mobile terminal device 100 newly obtains an image captured by the camera 120 when the predetermined time period passes (Operation 14). Image changing judgment processing is performed for the image obtained in Operation 14 and the image stored in Operation 12 (Operation 15). The image changing judgment processing will be described later.

As a result of the image changing judgment processing, if it is determined that there is no image change (Operation 16), the counter “n” for consecutive number of image change is reset to 0 (Operation 17). The process is returned to Operation 12 so as to write the image newly obtained in Operation 14.

As a result of the image changing judgment processing, if it is determined that there is an image change (Operation 16), the counter “n” for consecutive number of image change is incremented (Operation 18).

If the counter “n” for consecutive number of image change does not reach a prescribed number of times (Operation 19), the process is returned to Operation 12 so as to write the image newly obtained in Operation 14.

If the counter “n” for consecutive number of image change reaches the prescribed number of times (Operation 19), the power saving state of the display 130 is cancelled.

It is possible to perform the above-described judgment processing at the predetermined time interval. For example, if no image change is detected in five-time image obtaining, the process is interrupted for five seconds and five-time image obtaining is performed again. In this way, although no image change is detected during the five-second interruption period, it is possible to reduce the power used for camera capturing or the judgment processing. Thus, it is possible to save more power.

As a condition for putting the portable terminal 100 into the power saving state, there is a condition that the mobile terminal device 100 detects no image change more than the predetermined time period. Even if the display 130 is in the light-on state, the camera 120 is activated and the judgment processing is performed by the power saving controller 101 and the image changing detector 110. For example, the judgment processing is performed as shown in FIG. 5 after the last key operation if the mobile terminal device 100 is not in the power saving state. At this time, if the determination of Operation 19 is not “YES” more than the predetermined time period, the mobile terminal device 100 has only to go to the power saving state.

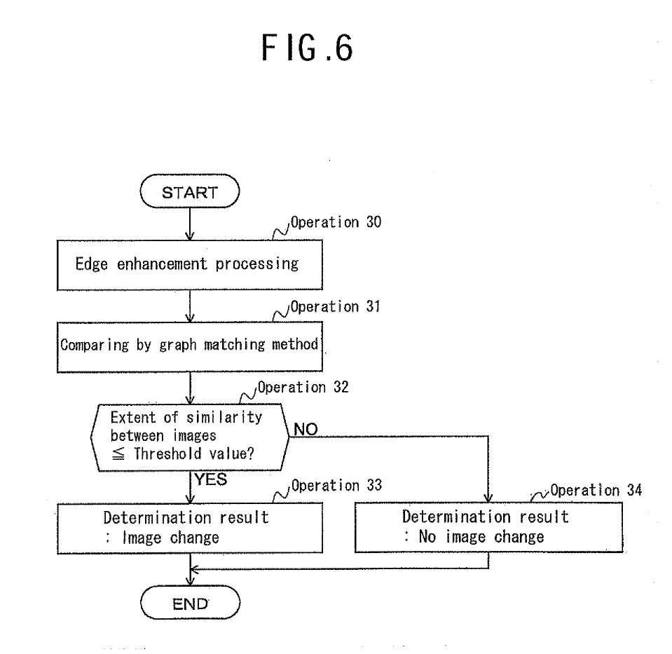

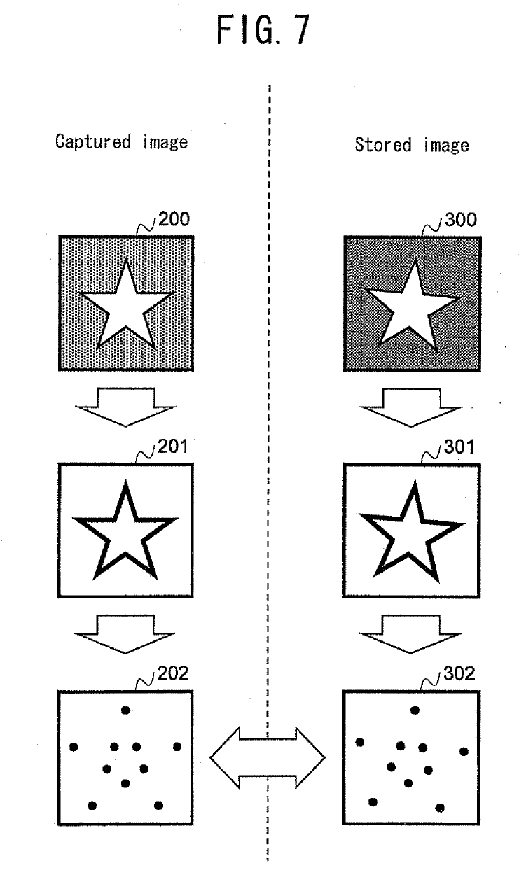

There may be considered various methods as methods for image changing judgment processing in Operation 15 as shown in FIG. 5. An example of image changing judgment processing performed by a graph matching method using FIG. 6 which shows a flow chart of image changing judgment processing and FIG. 7 which shows a diagram explaining image changing judgment processing of a present embodiment is explained.

First, the image changing judgment unit 113 performs edge enhancement processing (Operation 30) for the image captured by the camera 120, which is obtained by the captured image reader 111 at the timing (image 200 in FIG. 7), and the image which is previously obtained by the image storage unit 112 (image 300 in FIG. 7). A specific description is omitted because the edge enhancement processing is a well-known technology. In FIG. 7, an image 201 is a captured image 200 on which the edge enhancement processing is performed, and an image 301 is a stored image 300 on which the enhancement processing is performed.

Next, the image 201 on which the enhancement processing is performed is compared to the stored image 301 on which the enhancement processing is performed by the graph matching method (Operation 31). A specific description is omitted because the processing of the graph matching method is a well-known technology. In the graph matching method, an extent of similarity between graph-structured images is big when a distance between the images is small, and the extent of similarity between the images is small when the distance between the images is big. In FIG. 7, an image 202 is a graph structured image of the image 201 on which the edge enhancement processing is performed, and an image 302 is a graph structured image of the image 301 on which the edge enhancement processing is performed.

As a result of comparing the images by the graph matching method, it is determined whether or not there is an image change exceeding a certain extent (Operation 32). In the present embodiment using the threshold value, it is determined that there is an image change if the extent of similarity between the images is smaller than the threshold value (Operation 33), and it is also determined that there is no image change if the extent of similarity between the images is bigger than the threshold value (Operation 34).

There may be considered various methods as methods for detecting an image change between the images other than the methods shown in FIG. 6 and FIG. 7. For example, it may be determined that an image change is detected if an amount of brightness change exceeding the certain extent is detected when the captured image 200 is compared to the stored image 300, Also, a comparing range may include only a part of the image, e.g., the center of the image, instead of the whole image captured by the camera 120 in the comparing range. If the comparing range is narrow, an amount of the memory storing images can be reduced and a processing time for detecting an image change becomes short. Thus, it is possible to save more power.

The above-described judgment processing can be realized with a software which uses the main CPU 106 and the memory 107, and can also be realized by a hardware which does not use the main CPU 106 and the memory 107. It is possible to reduce power consumption in the power saving state if the judgment processing is realized by the hardware which does not use the main CPU 100 and the memory 107. In other words, the embodiments can be implemented in computing hardware and/or software.

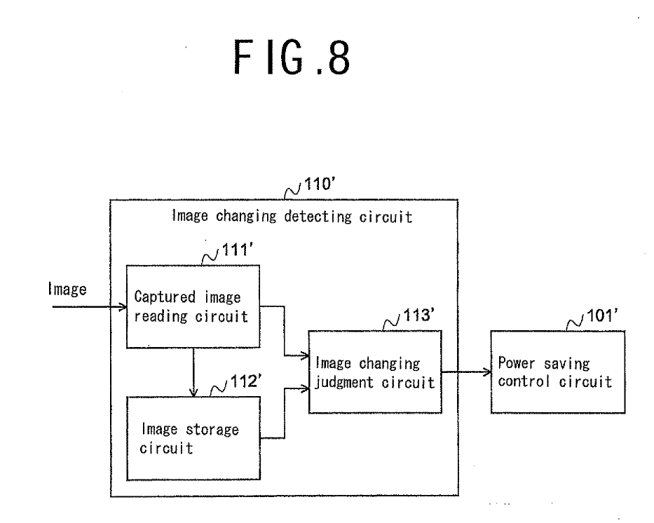

FIG. 8 is a hardware block diagram of an image changing detecting circuit. The judgment processing in the present embodiment is realized by an image changing detecting circuit 110′ detecting an image change between two images and a power saving control circuit 101′ controlling power saving. The image changing detecting circuit 110′ includes a captured image detecting circuit 111′ obtaining an image captured by the camera 120, an image storage unit 112′ storing the obtained image, an image changing judgment circuit 113′ determining an image change between the two images.

The power saving control circuit 101′ corresponds to the power saving control unit 101, and the image changing detecting circuit 110′ corresponds to the image changing detecting unit 110. The captured image detecting circuit 111′ corresponds to the captured image reader 111. The image storage circuit 112′ corresponds to the image storage unit 112. The image changing judgment circuit 113′ corresponds to the image changing judgment unit 113.

A signal of image obtained by a captured image reading circuit 111′ is transmitted to the image changing judgment circuit 113′ and the image storage circuit 112′. An image signal of the captured image reading circuit 111′ and an image signal stored by the image storage circuit 112′ are compared, and then a determination result signal is transmitted to the power saving control circuit 101′. The power saving control circuit 101′ controls the power saving state depending on the determination result signal transmitted from the image changing judgment circuit 113′.

In the present embodiment, even though the display is put into the light-off state by the power saving function, the power saving state is cancelled and the display is put into the light-on state if a user looks into the camera provided inside the mobile terminal device, or waves his/her hand in front of the camera provided inside the mobile terminal device. That is, in the present embodiment, it is possible to cancel the power saving state of the display without a key operation of the mobile terminal device. According to an aspect of an embodiment, any combinations of the described features, functions, and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A mobile terminal device having a display, the mobile terminal device comprising:
an image capturing unit obtaining an image captured at a prescribed periodical timing;
an image changing detector detecting an image change exceeding a prescribed extent between the image obtained by the image capturing unit at a prescribed timing and one or more of previously obtained images; and
a power saving controller controlling a power saving state of the display depending on whether an image change exceeding the prescribed extent is detected by the image changing detector.

2. The mobile terminal device according to claim 1, wherein the power saving controller controls the power saving state by cancelling the power saving state of the display, if an image change exceeding the prescribed extent is detected by the image changing detector.

3. The mobile terminal device according to claim 1, wherein the power saving controller controls the power saving state by cancelling the power saving state of the display, if an image change exceeding the prescribed extent is detected by the image changing detector at a consecutive timing more than a prescribed number of times.

4. The mobile terminal device according to claim 1, wherein the power saving controller controls the power saving state of the display, if an image change exceeding the prescribed extent is not detected more than a prescribed time period by the image changing detector.

5. A method of controlling power saving in a mobile terminal device having a display, the method comprising:
capturing an image at a prescribed periodical timing;
detecting an image change exceeding a prescribed extent between the captured image and one or more of previously captured images; and
controlling a power saving state of the display depending on whether an image change exceeding the prescribed extent is detected by the detecting of the image change.

6. The method of power saving control according to claim 5, wherein when the display is in the power saving state, the controlling of the power saving state comprises cancelling the power saving state of the display if an image change exceeding the prescribed extent is detected.

7. The method of power saving control according to claim 5, wherein when the display is in the power saving state, the controlling of the power saving state comprises cancelling the power saving state of the display if an image change exceeding the prescribed extent is detected between the images at a timing more than a prescribed consecutive number of times.

8. A computer-readable recording medium stores therein a computer program that causes a mobile terminal device having a display to execute operations comprising:
capturing an image at a prescribed periodical timing;
detecting an image change exceeding a prescribed extent between the captured image and one or more of previously captured images; and
controlling a power saving state of the display depending on whether an image change exceeding the prescribed extent is detected by the detecting of the image change.

9. The computer-readable recording medium according to claim 8, wherein when the display is in the power saving state, the power saving state of the display is cancelled if an image change exceeding the prescribed extent is detected.

10. The computer-readable recording medium according to claim 8, wherein when the display is in the power saving state, the power saving state of the display is cancelled if an image change exceeding the prescribed extent is detected between the images at a timing more than the prescribed consecutive number of times.

11. A mobile terminal device having an image capturing unit, the mobile terminal device comprising:
an image changing judgment unit comparing a first image captured by the image capturing unit at a first timing and a second image captured by the image capturing unit at a second timing which is different from the first timing, and determining whether there is an image change between the first image and the second image; and
a power saving control unit controlling the power saving state of the mobile terminal device based on a determination result produced by the image changing judgment unit.

12. The mobile terminal device according to claim 11, wherein the power saving control unit cancels the power saving state of the mobile terminal device which is in the power saving state, if an image change exceeds a prescribed extent between the first image and the second image according to the image changing judgment unit.

13. The mobile terminal device according to claim 11, wherein the image capturing unit captures images in prescribed time periods, and the image changing judgment unit compares a plurality of the images captured in the prescribed time periods.

14. A mobile device having a display and a camera, comprising:
a controller
controlling the camera for capturing an image at a prescribed periodical timing;
detecting an image change exceeding a prescribed extent between the captured image and one or more of previously captured images; and
determining a power saving state of the display according to an image change exceeding the prescribed extent.
